(19) United States
(12) Patent Application Publication
(10) Pub. No.: US 2008/0044216 A1
(43) Pub. Date: Feb. 21, 2008

(54) PAPER SIZE DETECTING APPARATUS AND IMAGE FORMING APPARATUS HAVING THE SAME

(75) Inventor: Hyun KIM, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/687,808

(22) Filed: Mar. 19, 2007

(30) Foreign Application Priority Data
Aug. 18, 2006 (KR) 2006-78316

(51) Int. Cl. B65H 1/00; B41J 29/00

(52) U.S. Cl. 400/708; 271/171

(57) ABSTRACT

A paper size detecting apparatus includes a paper width guider configured to move from side to side to set paper sheets loaded in a paper feeding part in a widthwise direction, a detecting sensor disposed at the paper width guider, and a detected band disposed at the paper feeding part in a widthwise direction of the paper sheets to face the detecting sensor.

### CROSS-REFERENCE TO RELATED APPLICATIONS

This application claims the priority under 35 U.S.C. § 119(a) from Korean Patent Application No. 2006-78316 filed Aug. 18, 2006 in the Korean Intellectual Property Office, the disclosure of which is incorporated herein by reference in its entirety.

### BACKGROUND OF THE INVENTION

1. Field of the Invention

The present general inventive concept relates to an image forming apparatus. More particularly, the present general inventive concept relates to a paper size detecting apparatus that can detect a paper size and has a simple structure, and an image forming apparatus having the same.

2. Description of the Related Art

Image forming apparatuses with a carriage has a detecting sensor disposed at the carriage and detecting a size of print sheets so that, when the carriage reciprocates, the detecting sensor can detect the size of the print sheets. Therefore, when the carriage moves in a horizontal direction for printing, the detecting sensor can detect whether there is a paper sheet in a printing area, and the size of the paper sheet.

On the other hand, array head printers do not have a carriage reciprocating as described above. Therefore, the array head printers need to have a plurality of sensors corresponding to various sizes of paper sheets for detecting sizes of the paper sheets. A lot of sensors for detecting size of paper sheets increase a manufacturing cost of the array head printer.

Also, image forming apparatuses with a paper feeding cassette have a plurality of detecting sensors disposed in the paper feeding cassette for detecting size of paper sheets loaded in the paper feeding cassette so as to properly control a printing process according to the size of the paper sheet. However, there are problems that it has a lot of parts and a complex structure so that manufacturing costs and assembly time are increased.

### SUMMARY OF THE INVENTION

The present general inventive concept provides a paper size detecting apparatus that can detect a size of various paper sheets with a simple structure at a low cost, and an image forming apparatus having the same.

Additional aspects and advantages of the present general inventive concept will be set forth in part in the description which follows and, in part, will be obvious from the description, or may be learned by practice of the general inventive concept.

The above and/or other aspects and feature of the present general inventive concept may be achieved by providing a paper size detecting apparatus, which includes a paper width guider configured to move from side to side to set one or more paper sheets loaded in a paper feeding part in a widthwise direction, a detecting sensor disposed at the paper width guider, and a detected band disposed at the paper feeding part in a widthwise direction of the paper sheets to face the detecting sensor.

The detected band may be configured in a format such that a depth of color varies along a length of the detected band. The detected band may include a gray patch having colors that gradually become lighter from a first end to a second end, or a color patch having various colors at predetermined intervals.

The detecting sensor may include an emitting part to emit light to the detected band, and a receiving part to receive light reflected by the detected band.

The detected band may be configured in a format such that a width of the detected band is gradually either decreased or increased from a first end to a second end.

The detecting sensor may include a size-detecting sensor that is disposed at the paper width guider and detects a width of the detected band according to a position of the paper width guider.

The detected band may be configured in an inclined band such that a height of the inclined band is gradually either decreased or increased from a first end to a second end.

The detecting sensor may include a distance-detecting sensor that is disposed at the paper width guider and detects a height of the detected band according to a position of the paper width guider.

The foregoing and/or other aspects of the present general inventive concept may also be achieved by providing an image forming apparatus including a paper feeding part having paper sheets loaded, and a paper size detecting apparatus disposed the paper feeding part and having a paper width guider configured to move from side to side to set one or more paper sheets loaded in a paper feeding part in a widthwise direction, a detecting sensor disposed at the paper width guider, and a detected band disposed at the paper feeding part in a widthwise direction of the paper sheets to face the detecting sensor to detect a size of the paper sheet.

The foregoing and/or other aspects of the present general inventive concept may also be achieved by providing an image forming apparatus including a paper feeding part to feed one or more paper sheets along a paper feeding path in a first direction, a band disposed on the paper feeding path in a second direction having an angle with the first direction at the paper feeding part and having different characteristics of different lengths corresponding to sizes of the paper sheets, and a detecting sensor movable along the band to detect the different characteristics of the different lengths so as to determine the sizes of the paper sheets.

The foregoing and/or other aspects of the present general inventive concept may also be achieved by providing an image forming apparatus including a paper feeding part having a first portion on which one or more paper sheets are loaded, to feed the paper sheet in a first direction, a band disposed in a second direction on a second portion of the paper feeding part to receive the fed paper sheet, and having characteristics of different lengths corresponding to sizes of the paper sheets, and a detecting sensor movable along the band to detect the characteristics of the different lengths so as to determine the sizes of the paper sheets.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view schematically illustrating an image forming apparatus having a paper size detecting apparatus according to an embodiment of the present general inventive concept;

FIG. 2 is an enlarged perspective view illustrating the paper size detecting apparatus of FIG. 1;

FIG. 3 is a view illustrating a detected band according to an embodiment of the present general inventive concept;

FIG. 4 is a view illustrating a detected band according to an embodiment of the present general inventive concept;

FIG. 5 is a view illustrating a detected band according to an embodiment of the present general inventive concept; and

FIG. 6 is a view illustrating a detected band according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The matters defined in the description, such as a detailed construction and elements thereof, are provided to assist in a comprehensive understanding of the invention. Thus, it is apparent that the present general inventive concept may be carried out without those defined matters. Also, well-known functions or constructions are omitted to provide a clear and concise description of exemplary embodiments of the present general inventive concept.

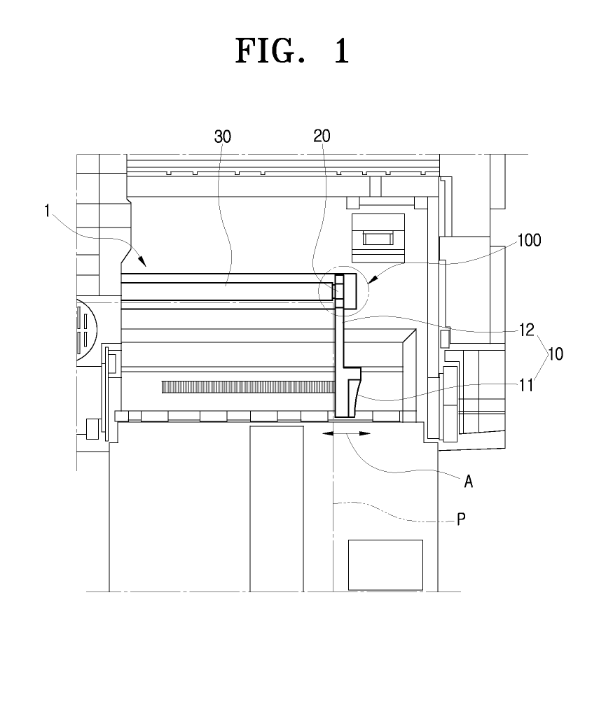

FIG. 1 is a view schematically illustrating an image forming apparatus having a paper size detecting apparatus according to an embodiment of the present general inventive concept.

Referring to FIG. 1, the image forming apparatus includes a paper feeding part 1, and a paper size detecting apparatus 100 to detect a size of one or more paper sheets P loaded in the paper feeding part 1.

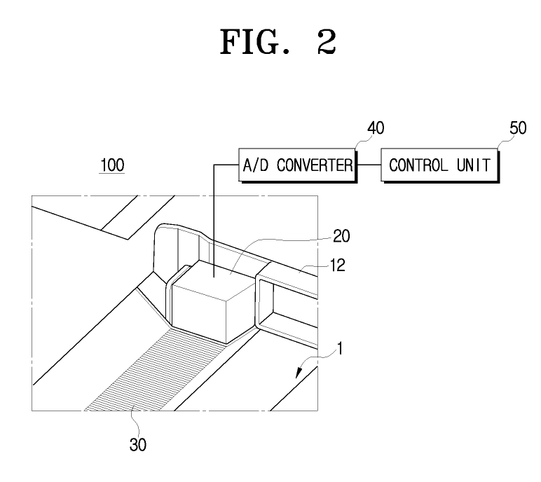

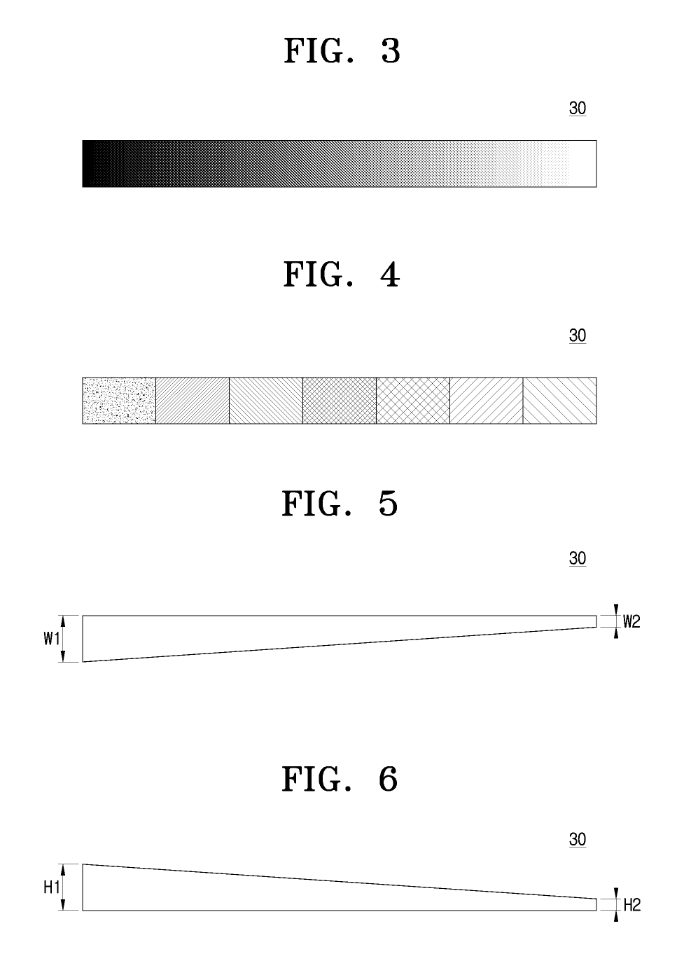

The paper size detecting apparatus 100 includes a paper width guider 10, a detecting sensor 20, and a detected band 30 as illustrated in FIGS. 2 and 3.

The paper width guider 10 is disposed in the paper feeding part 1 of the image forming apparatus so as to reciprocate from side to side in a direction of an arrow A as illustrated in FIG. 1. Therefore, the paper width guider 10 sets the paper sheets P loaded in the paper feeding part 1 in a widthwise direction. The paper width guider 10 includes a body 12 to push sides of the paper sheet P, and a handle 11 formed integrally with the body as a user's grip.

The detecting sensor 20 is disposed at an end of the paper width guider 10, and includes a non-contact optical sensor like LED sensors having an emitting part and a receiving part. The detecting sensor 20 is electrically connected to a control unit 50 through an analog/digital (A/D) converter 40 as illustrated in FIG. 2, and gives an analog detecting signal corresponding to a characteristic, for example, a depth (darkness) of color, of the detected band 30. Respective depths of color may have different lengths to detect corresponding paper sizes of the paper sheets P.

The detected band 30 may be disposed on a surface facing the detecting sensor 20. The detected band 30 may be separately formed, and may be attached to a bottom surface of the paper feeding part 1 as illustrated in FIG. 2. Also, the detecting sensor 30 is apart from the detected band 30 so that when the paper width guider 10 reciprocates from side to side, the detecting sensor 20 does not touch the detected band 30. As a result, the detected band 30 is not worn by friction.

According to the embodiment of the present general inventive concept, the image forming apparatus may include the paper feeding part 1 to feed one or more paper sheets P along a paper feeding path in a first direction, the detected band 30 disposed on the paper feeding path in a second direction having an angle with the first direction at the paper feeding part 1, and having characteristics of different lengths corresponding to sizes of the paper sheets P, and a detecting sensor movable along the band to detect the characteristics of the different lengths so as to determine the sizes of the paper sheets. Here, the arrow A may be the second direction, and the first direction and the paper feeding path may be perpendicular to the second direction.

The paper feeding part 1 includes the paper width guider 10 disposed in the first direction and movable in the second direction to correspond to the respective sizes of the paper sheets P, and the detecting sensor 20 is mounted on the paper width guider 10 to move along the detected band 30. The paper width guider 10 and the detecting sensor 20 may be formed in a single body. The paper width guider 10 includes the body 12 disposed in the first direction, and the body 12 comprises a first end formed with the detecting sensor 20 and a second end formed with the handle 11 to move the body 12 in the second direction. The paper width guider 10 and the detecting sensor 20 may be disposed on a same surface of the paper feeding part 1 in the paper feeding path.

It is possible that the paper feeding part 1 may include a surface on which the one or more paper sheets P are placed, and the band 30 is disposed on the surface of the paper feeding part 1, so that the detecting sensor 20 faces the band 30. The surface may include a first portion to be covered by the paper sheets P when the paper sheets P are loaded in the paper feeding part 1, for example, in a paper cassette or paper loading plate, and a second portion disposed to receive the fed paper sheet P from the first surface, and the detecting band 30 is disposed on the second portion of the surface of the paper feeding part 1. The paper feeding part 1 may include a first surface one which the paper sheets P are placed, and the band 30 is disposed on a second surface disposed in the first direction from the first surface. The first surface and the second surface may be disposed in the first direction and may be spaced-apart from the second surface in the first direction.

According to the present embodiment, the image forming apparatus may include the paper feeding part 1 having a first portion on which one or more paper sheets P are loaded, to feed the paper sheet in a first direction, the band 30 disposed in a second direction on a second portion of the paper feeding part 1 to receive the fed paper sheet P, and having characteristics of different lengths corresponding to sizes of the paper sheets P, and the detecting sensor 20 movable along the band 30 to detect the characteristics of the different lengths so as to determine the sizes of the paper sheets P.

The image forming apparatus may further include the paper width guider 10 disposed on the first portion of the paper feeding part to move according to the sizes of the paper sheets P, and extended to the second portion of the paper feeding part, and the detecting sensor 20 may be disposed on the second portion of the paper feeding part 12 to move together with the paper width guider 10 along the band 30. Here, the first portion is covered by the paper sheet P when the paper P is loaded in the first portion, and the second portion is covered by the paper sheet P when the paper sheet P is fed in the first direction by the paper feeding part 1. It is possible that the second portion is not covered by the paper sheet P when the paper sheet P is loaded in the first portion, and that the first portion and the second portion are arranged in the first direction in which the paper sheet P is fed.

The A/D converter 40 converts analog signals from the detecting sensor 20 into digital signals, and sends the digital signals to the control unit 50. In other words, light emitting from the emitting part of the detecting sensor 20 is reflected by the detected band 30, and enters the receiving part. The strength of light entering the receiving part is weaker than the strength of the light emitting from the emitting part. At this time, the strength of light entering the receiving part varies corresponding to the depth of color of the detected band 30 reflecting the light. Therefore, the detecting sensor 20 gives analog signals varying with the depth of color of the detected band 30 reflecting light. The analog signals are converted into predetermined digital signals by the A/D converter 40. The control unit 50 determines a size of the paper sheet P using the digital signals.

The control unit 50 has saved reference values of the depth of colors corresponding to sizes of various paper sheets P. When the control unit 50 compares a signal from the detecting sensor 20 with the reference values, the control unit 50 can determine a size of the paper sheets loaded in the paper feeding part 1.

In an ink-jet printer or an array head printer, after the control unit 50 determines size of the paper sheets from the signal of the detecting sensor 20, the control unit 50 controls a firing nozzle position, that is, a position in which nozzles start to jet ink according to the size of the paper sheet. Also, in a laser printer, the control unit 50 can control a position in which an electrostatic image is formed.

On the other hand, the detected band 30 may be formed in various shapes.

Referring to FIG. 3, the detected band 30 is formed in a gray patch such that its first end is black, its second end is white, and there are a series of achromatic tones having varying proportions of white and black between the first and second ends. In other words, the detected band is configured in a format such that colors gradually become lighter from the first end to the second end.

Using the detected band 30 according to the present embodiment, the detecting sensor 20 gives a different signal according to the depth (darkness) of color of the detected band 30 so that the control part 50 can determine the size of the paper sheet loaded in the paper feeding part 1 through the detecting sensor 20. The depths of color may vary.

The detected band 30 according to another embodiment of the present general inventive concept is formed in a color patch having various colors arranged at predetermined intervals as illustrated in FIG. 4. The detected band 30 may be formed so that the various colors are set to be different from each other at positions in which the paper width guider 10 is located according to a size of each of various paper sheets, namely, at positions in which the detecting sensor 20 is located. As a result, the detecting sensor 20 gives various signals according to colors representing sizes of various paper sheets. The various colors may have different lengths different from each other. The lengths of the various colors may correspond to different paper sizes, for example, an A4 size paper or a letter size paper. The length of color on an end of the detected band 30 may have a minimum length longer than a minimum size of the paper sheet P, so that a remaining portion of color is not covered by the minimum size paper and is detected. A side of the minimum size sheet is disposed in the color. A second length of a second color adjacent to the color corresponding to the minimum size of the paper sheet P may be a difference between the minimum length and a length of a third minimum size, so that a side of a second minimum size of the paper sheet P can be disposed in the second color and the second minimum size paper can be detected by a remaining portion of the second length of the color which is not covered by the second minimum size paper sheet.

The detected band 30 according to another embodiment of the present general inventive concept is formed in a tapered band such that a first end width W1 is wider than a second end width W2 as illustrated in FIG. 5. The detecting sensor 20 can detect a width of the detected band 30 according to a position of the paper width guider 10. At this time, the detecting sensor 20 comprises a size-detecting sensor capable of detecting a width of the detected band 30. It is possible that there are steps between the adjacent tapered portions, so that lengths of the depths of the tapered portions are different from each other to correspond to the respective paper sheets having different sizes.

Also, the detected band 30 according to a fourth embodiment of the present invention is formed in an inclined band such that its top surface is inclined and a height of the detected band 30 varies from h1 to h2 as shown in FIG. 6. The detecting sensor 20 can detect a distance between the detected band 30 and the detecting sensor 20 according to a position of the paper width guider 10. At this time, the detecting sensor 20 comprises a distance-detecting sensor capable of detecting a distance to the top surface of the detected band 30. It is possible that there are steps between the adjacent tapered portions, so that lengths of the depths of the tapered portions are different from each other to correspond to the respective paper sheets having different sizes.

When the detected band 30 has either a taper shape as illustrated in FIG. 5 or an inclined surface as illustrated in FIG. 6, the detecting sensor 30 detects a change of the shape of the detected band 30 so as to give different signals according to positions of the paper width guider 10. Therefore, the control unit 50 can determine the size of the paper sheet using the signal from the detecting sensor 20 as embodiments described above. It is also possible that a combination of the detected bands 30 of FIGS. 3-6 may be used to respectively represent the corresponding paper sheets.

With the paper size detecting apparatus according to the present invention as described above, a non-contact detecting sensor like LED sensors with an emitting part and a receiving part is disposed at the paper width guider. Therefore, when a user sets paper sheets loaded in the paper feeding part, the control part can determine the size of the paper sheets. Also, the paper size detecting apparatus according to the present invention does not need a complicated mechanism for determining the size of the paper sheets so that its assembly time and manufacturing cost are decreased.

In the paper size detecting apparatus according to an embodiment of the present general inventive concept, the detecting sensor is disposed at the paper width guider supporting the loaded paper sheets in a widthwise direction, and can detect a size of the loaded paper sheets using either the depth of color or the change of the shape of the detected band. Therefore, the paper size detecting apparatus can determine the size of the loaded paper sheets at the same time as a user set the paper sheets loaded in the paper feeding part.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A paper size detecting apparatus comprising:
a paper width guider configured to move from side to side to set one or more paper sheets loaded in a paper feeding part in a widthwise direction;
a detecting sensor disposed at the paper width guider; and
a detected band disposed at the paper feeding part in a widthwise direction of the paper sheets to face the detecting sensor.

2. The paper size detecting apparatus of claim 1, wherein the detected band is configured in a format such that a depth of color varies along a length of the detected band.

3. The paper size detecting apparatus of claim 2, wherein the detected band comprises a gray patch having colors that gradually become lighter from a first end to a second end.

4. The paper size detecting apparatus of claim 2, wherein the detected band comprises a color patch having various colors at predetermined intervals.

5. The paper size detecting apparatus of claim 2, wherein the detecting sensor comprises an emitting part emitting light to the detected band, and a receiving part receiving light reflected by the detected band.

6. The paper size detecting apparatus of claim 1, wherein the detected band is configured in a format such that a width of the detected band is gradually either decreased or increased from a first end to a second end.

7. The paper size detecting apparatus of claim 6, wherein the detecting sensor comprises a size-detecting sensor that is disposed at the paper width guider and detects a width of the detected band according to a position of the paper width guider.

8. The paper size detecting apparatus of claim 1, wherein the detected band is configured in an inclined band such that a height of the inclined band is gradually either decreased or increased from a first end to a second end.

9. The paper size detecting apparatus of claim 8, wherein the detecting sensor comprises a distance-detecting sensor that is disposed at the paper width guider and detects a height of the detected band according to a position of the paper width guider.

10. An image forming apparatus comprising:
a paper feeding part having one or more paper sheets loaded;
a paper width guider configured to move from side to side to set the paper sheets loaded in the paper feeding part in a widthwise direction;
a detecting sensor disposed at the paper width guider; and
a detected band disposed at the paper feeding part in a widthwise direction of the paper sheets to face the detecting sensor.

11. The image forming apparatus of claim 10, wherein the detected band is configured in a format such that a depth of color varies along a length of the detected band.

12. The image forming apparatus of claim 11, wherein the detected band comprises a gray patch having colors that gradually become lighter from a first end to a second end.

13. The image forming apparatus of claim 11, wherein the detected band comprises a color patch having various colors at predetermined intervals.

14. The image forming apparatus of claim 11, wherein the detecting sensor comprises an emitting part emitting light to the detected band, and a receiving part receiving light reflected by the detected band.

15. The image forming apparatus of claim 10, wherein the detected band is configured in a format such that a width of the detected band is gradually either decreased or increased from a first end to a second end.

16. The image forming apparatus of claim 15, wherein the detecting sensor comprises a size-detecting sensor that is disposed at the paper width guider and detects a width of the detected band according to a position of the paper width guider.

17. The image forming apparatus of claim 10, wherein the detected band is configured in an inclined band such that a height of the inclined band is gradually either decreased or increased from a first end to a second end.

18. The image forming apparatus of claim 17, wherein the detecting sensor comprises a distance-detecting sensor that is disposed at the paper width guider and detects a height of the detected band according to a position of the paper width guider.

19. The image forming apparatus of claim 10, wherein the detected band has different characteristics having different lengths along a lengthwise direction.

20. An image forming apparatus comprising:
a paper feeding part to feed one or more paper sheets along a paper feeding path in a first direction;
a band disposed on the paper feeding path in a second direction having an angle with the first direction at the paper feeding part and having characteristics of different lengths corresponding to sizes of the paper sheets; and
a detecting sensor movable along the band to detect the characteristics of the different lengths so as to determine the sizes of the paper sheets.

21. The image forming apparatus of claim 20, wherein the paper feeding part comprises a paper width guider disposed in the first direction and movable in the second direction to correspond to the respective sizes of the paper sheets, and the detecting sensor is disposed on the paper width guider to move along the band.

22. The image forming apparatus of claim 21, wherein the paper width guider and the detecting sensor are formed in a single body.

23. The image forming apparatus of claim 21, wherein the paper width guider comprises a body disposed in the first direction, and the body comprises a first end formed with the detecting sensor and a second end formed with a handle to move the body in the second direction.

24. The image forming apparatus of claim 21, wherein the paper width guider and the detecting sensor are disposed on a same surface of the paper width guider.

25. The image forming apparatus of claim 20, wherein the paper feeding part comprises a surface on which the paper sheet are placed, and the band is disposed on the surface of the paper feeding part, so that the detecting sensor faces the band.

26. The image forming apparatus of claim 25, wherein the surface comprises a first portion to be covered by the paper sheets when the paper sheets are loaded in the paper feeding part, and a second portion disposed to receive the fed paper sheet from the first surface, and the detecting band is disposed on the second portion of the surface of the paper feeding part.

27. The image forming apparatus of claim 20, wherein the paper feeding part comprises a first surface one which the paper sheets are placed, and the band is disposed on a second surface disposed in the first direction from the first surface.

28. The image forming apparatus of claim 20, wherein the paper feeding part comprises a first surface one which the paper sheets are placed, and a second surface on which the band is disposed, and the first surface and the second surface are disposed in the first direction.

29. The image forming apparatus of claim 20, wherein the paper feeding part comprises a first surface one which the paper sheets are placed, and a second surface on which the band is disposed, and the first surface and the second surface are spaced apart in the first direction.

30. An image forming apparatus comprising:
a paper feeding part having a first portion on which one or more paper sheets are loaded, to feed the paper sheet in a first direction;
a band disposed in a second direction on a second portion of the paper feeding part to receive the fed paper sheet, and having characteristics of different lengths corresponding to sizes of the paper sheets; and
a detecting sensor movable along the band to detect the characteristics of the different lengths so as to determine the sizes of the paper sheets.

31. The image forming apparatus of claim 30, further comprising:
a paper guider disposed on the first portion of the paper feeding part to move according to the sizes of the paper sheets, and extended to the second portion of the paper feeding part,
wherein the detecting sensor is disposed on the second portion of the paper feeding part to move together with the paper guider along the band.

32. The image forming apparatus of claim 30, wherein the first portion is covered by the paper sheet when the paper is loaded in the first portion, and the second portion is covered by the paper sheets when the paper sheet is fed in the first direction by the paper feeding part.

33. The image forming apparatus of claim 30, wherein the first portion is covered by the paper sheet when the paper is loaded in the first portion, and the second portion is not covered by the paper sheet when the paper is loaded in the first portion.

34. The image forming apparatus of claim 30, wherein the first portion and the second portion are arranged in the first direction in which the paper sheet is fed.
